(19) United States
(12) Patent Application Publication
(10) Pub. No.: US 2008/0240225 A1
(43) Pub. Date: Oct. 2, 2008

(54) METHOD AND SYSTEM FOR ENHANCING THE PERFORMANCE OF WIDEBAND DIGITAL RF TRANSPORT SYSTEMS

(75) Inventors: Dean Zavadsky, Shakopee, MN (US); Philip M. Wala, Waseca, MI (US); John M. Hedin, Coon Rapids, MN (US); Steven B. Stuart, Eden Prairie, MN (US)

Correspondence Address: FOGG & POWERS LLC, 10 SOUTH FIFTH STREET, SUITE 1000, MINNEAPOLIS, MN, 55402, US

(73) Assignee: ADC TELECOMMUNICATIONS, INC., Eden Prairie, MN (US)

(21) Appl. No.: 11/692,032

(22) Filed: Mar. 27, 2007

(51) Int. Cl. H04L 1/02

(52) U.S. Cl. 375/240; 375/E07.067

(57) ABSTRACT

A method and system for enhancing the performance of wideband digital RF transport systems, which enables the selection of a serial data rate to be transported over a transport medium. Thus, the present invention allows the system to be adapted to different transport mediums, and allows the user to set the serial data rate based on the input bandwidth of the system. The present invention also enables the transport of different bandwidth segments on a plurality of wideband channels by selecting an optimal clock sample rate for each bandwidth segment to be transported. Thus, the present invention allocates the bandwidth segments proportionally so that an optimum amount of bandwidth can be transported at the serial bit rate.

### CROSS REFERENCE TO RELATED APPLICATIONS

This application is related to copending U.S. patent application Ser. No. 11/398,879 having a title of “SYSTEM AND METHOD FOR ENHANCING THE PERFORMANCE OF WIDEBAND DIGITAL RF TRANSPORT SYSTEMS” (also referred to here as the '879 Application). The '879 Application is hereby incorporated herein by reference.

### FIELD OF THE INVENTION

The present invention relates generally to the telecommunications field, and more specifically, but not exclusively, to a method and system for enhancing the performance of wideband digital Radio Frequency (RF) transport systems.

### BACKGROUND OF THE INVENTION

In wireless voice and data communications, the digital transport of RF signals over long distances via fiber optic cables provides enhanced capacity, and higher performance distributed coverage than existing analog RF transport systems currently being used. An example of such a digital RF transport system that links a digital host unit to one or more digital remote units to perform bi-directional simultaneous digital RF distribution is disclosed in U.S. Patent Application Publication No. 2004/0132474 A1, entitled “POINT-TO-MULTIPOINT DIGITAL RADIO FREQUENCY TRANSPORT”, which is assigned to ADC Telecommunications, Inc. of Eden Prairie, Minn. and incorporated herein in its entirety.

Notwithstanding the advantages of today's digital RF transport systems over other types of RF transport systems, a significant problem exists in the transport of large amounts of digital RF bandwidth (e.g., wideband). For example, the existing wideband digital RF transport systems combine multiple digitized signals and convey them in serialized form on a common physical layer between the transmit and receive devices involved. However, the problem with the existing digital RF transport systems is that they inefficiently transport equal amounts of bandwidth for different wideband channels. In other words, the serial bit streams on the transport layer that convey N wideband channels are all tied to one sample rate, and the system transport spectrum (RF) is sent point-to-point in equal bandwidth segments (e.g., 25 MHz blocks). Consequently, since many of the wideband channels have bandwidth requirements that are less (or different) than 25 MHz (e.g., 5 MHz, 10 MHz, 30 MHz, etc.), the overall bandwidths of existing wideband digital RF transport systems are substantially underutilized.

Additionally, present systems are designed for a single serial data rate and a single mode of serial transmission. Thus, existing systems must be completely replaced to use a new mode of serial transmission at a different serial data rate. Also, since existing systems are designed for a single data rate only, the existing systems will transmit at the designed serial data rate, regardless of how much input bandwidth the system is transporting. This often results in the transmission of empty data to fill the serial bandwidth of the transport medium.

Therefore, a pressing need exists for a system and method that can enhance the performance of wideband digital RF transport systems, by custom tailoring the bandwidth allocations to specific user needs on a common platform, custom tailoring the serial data rate to user needs and transport requirements, and enabling the use of lower cost transport system devices. As described in detail below, the present invention provides such a method and system, which resolves the above-described bandwidth underutilization problems and other related problems.

### SUMMARY OF THE INVENTION

The present invention provides a method and system for enhancing the performance of wideband digital RF transport systems, which enables the selection of a serial data rate to be transported over a transport medium. Thus, the present invention allows the system to be adapted to different transport mediums, and allows the user to set the serial data rate based on the input bandwidth of the system. The present invention also enables the transport of different bandwidth segments on a plurality of wideband channels by selecting an optimal clock sample rate for each bandwidth segment to be transported. Thus, the present invention allocates the bandwidth segments proportionally so that an optimum amount of bandwidth can be transported at the serial bit rate.

In accordance with a preferred embodiment of the present invention, a system for enhancing the performance of a wideband digital RF transport system is provided, which includes a transmit unit, a receive unit, and an optical transmission medium connected between the transmit unit and the receive unit. The transmit unit includes a plurality of wideband RF analog signal inputs coupled to a plurality of analog-to-digital, digital down-converter (A/D DDC) devices. Notably, the sample rate of each A/D DDC device is determined by a respective sample clock. The digitized wideband RF signal segments at the outputs of the A/D DDC devices are combined. A serial data rate is set for serial transmission of the bandwidth. The combined wideband RF signal segments are converted to a frame structure based on the set serial rate. The frame structure is then converted to serial form, and transmitted on the optical transmission medium to the receive unit. A light detection device in the receive unit detects the serial bit stream of frames on the optical transmission medium, the serialized frames are converted back to the original frame format, and the original digitized wideband RF segments are reconstructed. Each digitized wideband RF segment is coupled to a respective D/A digital up-converter (D/A DUC) device associated with a particular wideband RF signal input on the transmit side. Notably, the output sample rate of each D/A DUC device is determined by a respective sample clock, which provides the same sample rate as that of the associated A/D DDC device in the transmit unit. The sample rate of each A/D DDC device (and associated D/A DUC device) is pre-selected so that the transmission medium can transport the optimum amount of RF bandwidth at the given serial bit rate.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawing(s), wherein:

FIG. 1 depicts a schematic block diagram of an example system for enhancing the performance of wideband digital RF transport systems, which can be used to implement a preferred embodiment of the present invention;

FIG. 2 depicts a pictorial representation of an example frame structure, which illustrates key principles of the present invention; and

FIG. 3 depicts a flow chart of an example method for enhancing the performance of wideband digital RF transport systems.

### DETAILED DESCRIPTION OF PREFERRED EMBODIMENT

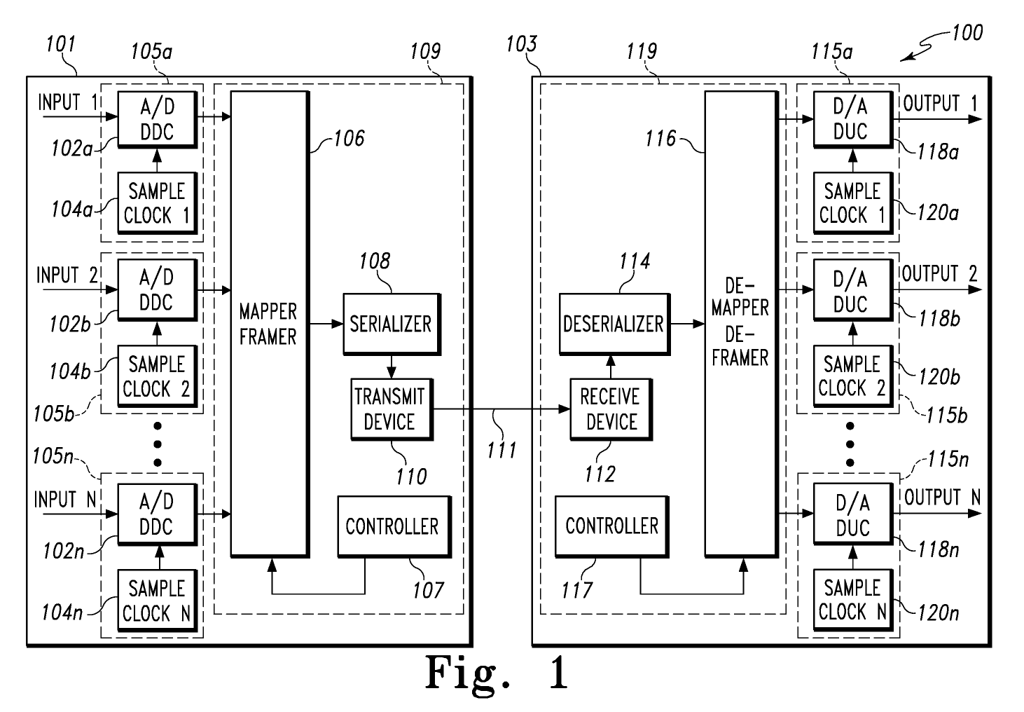

With reference now to the figures, FIG. 1 depicts a schematic block diagram of an example system 100 for enhancing the performance of wideband digital RF transport systems, which can be used to implement a preferred embodiment of the present invention. System 100 includes a first communications unit 101, a second communications unit 103, and a transmission (transport) medium 111 connected between first communications unit 101 and second communications unit 103. For this example embodiment, first communications unit 101 is a wideband digital RF transmit unit, second communications unit 103 is a wideband digital RF receive unit, and transmission medium 111 is a single mode (or multi-mode) optical fiber. Although system 100 is depicted for illustrative purposes as a unidirectional communications system, the scope of coverage of the present invention is not intended to be so limited, and system 100 could also be implemented as a bi-directional communications system (e.g., using a transceiver on each side). Also, for this illustrative example, system 100 may be implemented as a point-to-point digital RF transport system for cellular radiotelephone voice and data communications, with a digital host unit (first communications unit 101) that provides an interface between a plurality of base station RF ports and the optical fiber, and a digital remote unit (second communications unit 103) that provides an interface between the optical fiber and a remote antenna. Additionally, although the transmission medium 111 is described as an optical transmission medium for this illustrative embodiment, the present invention is not intended to be so limited and can include within its scope any suitable transmission medium (e.g., millimeter wave radio link, microwave radio link, satellite radio link, infrared wireless link, coaxial cable, etc.) capable of transporting a serial bit stream.

For this example embodiment, first communications unit 101 includes a plurality of input interfaces 102a-102n. Each input interface 102a-102n is implemented with an A/D DDC device, for this illustrative embodiment. An input of each A/D DDC device 102a-102n couples a respective analog frequency band (or channel) into the associated A/D DDC device. For example, each A/D DDC device 102a-102n can accept an input analog frequency band (e.g., frequency band from a base transceiver station) at a relatively high rate, and digitizes and down-converts the respective frequency band to suitable digital real and complex (e.g., I/Q) baseband signals. For example, the output from each A/D converter section of an A/D DDC device 102a-102n can be a sequence of real samples, representing a real (symmetric positive and negative frequencies) signal within a designated Nyquist zone. The output from each DDC section can be a baseband signal (centered at zero Hz) with non-symmetric positive and negative frequencies, composed of two sample streams (real and imaginary components) with each stream at one half the sample rate of the equivalent real-valued signal.

Notably, in the example embodiment depicted in FIG. 1, the input interfaces 102a-102n to communications unit 101 are implemented with a plurality of A/D DDC devices that can accept a plurality of analog RF bandwidths, but the present invention is not intended to be so limited. In other embodiments, the input interfaces can be implemented with other types of input devices to accept other types of bandwidths. For example, in order to accept a plurality of RF inputs, each input interface device 102a-102n can be implemented with a single A/D converter (no DDC) operating at IF (e.g., real digital output), dual A/D converters (no DDC) operating at baseband (e.g., complex I/Q digital output), or single or dual A/D converters operating at a high sample rate and followed by digital down-conversion (DDC) whereby the output is a lower sample rate representation (complex I/Q) of a portion of the original band. In another embodiment, each input interface device 102a-102n can be implemented by a direct digital input (typically baseband I/Q) from a digital or “software-defined” base station. In sum, the plurality of input interfaces 102a-102n can be implemented with any suitable input interface device(s) capable of accepting or inputting analog or digital wideband segments.

For this example embodiment, each A/D DDC device 102a-102n can be implemented as part of a modular (e.g., pluggable) RF DART (Digital to Analog Radio Transceiver) card 105a-105n capable of adjustable bandwidth selection that can be determined by user requirements. For example, in one embodiment, each A/D DDC device 102a-102n can be implemented as part of a DART card that passes 5 MHz bandwidth segments. Notably, the sample rate of each A/D DDC device 102a-102n is determined by an associated sample clock 104a-104n. Therefore, by selecting a suitable sample rate for each A/D DDC device 102a-102n, the present invention provides the ability to custom tailor the bandwidth allocations to specific user needs on the common transport platform being used. For this example embodiment, each associated sample clock 104a-104n can also be implemented as part of the respective modular DART card 105a-105n.

For example, one or more users may desire to transport a combination of one 5 MHz segment and three 15 MHz segments from a digital host unit (e.g., first communications unit 101) to a digital remote unit (e.g., second communications unit 103) via an optical fiber (e.g., transmission medium 111). For a given serial bit rate on the optical fiber, a suitable sample rate may be selected for the sample clock 104a-104n associated with each A/D DDC device 102a-102n to be used. For this example, assume that the 5 MHz segment is to be input to A/D DDC device 102a, and each of A/D DDC devices 102b, 102c and 102d (where “n” in this case is equal to 4) is designed to accept a respective one of the three 15 MHz segments to be transported. The sample rate for sample clock 104a is selected to accommodate the transport of the 5 MHz segment (band) at the given serial bit rate, and the sample rates for sample clocks 104b-104d are selected to accommodate the transport of the respective 15 MHz segments at the given serial bit rate. In a practical application, the sample rates (e.g., approximately 45 Msps) of sample clocks 104b-104d are typically three times the sample rate of sample clock 104a (e.g., approximately 15 Msps) for a given serial bit rate on an optical fiber. In any event it should be readily understood that the present invention is not intended to be limited to a particular set of clock sample rates, the size of a frequency band that can be accepted by a specific A/D DDC device, the size of the frequency bands to be transported, or the serial bit rate for the optical transmission medium to be used.

For example, a suitable clock sample rate can be selected to accommodate the transport of a 75 MHz segment (e.g., at 15 times the clock sample rate used for a 5 MHz segment) from the input of a particular A/D DDC device via an optical fiber at a specific serial bit rate. As another example, assume that each A/D DDC device 102a-102n is designed to process a 10 MHz band of frequencies. In this case, a suitable sample rate for each sample clock can be selected to accommodate the transport of a 10 MHz band and/or a band that is a multiple of 10 MHz (e.g., 30 MHz band at three times the sample rate of the sample rate used for the 10 MHz band). In other words, the present invention enables a user to transport just the required amount of bandwidth for each A/D DDC device.

For this example embodiment, the digitized output of each A/D DDC device 102a-102n is coupled to a mapper/framer device 106. Essentially, the mapper section of mapper/framer device 106 multiplexes together the digitized bands at the outputs of the plurality of A/D DDC devices 102a-102n, and the framer section of mapper/framer device 106 converts the multiplexed digitized bands into a suitable frame structure format.

Mapper/framer device 106 is capable of adjustable frame size selection that can be determined by user requirements. In this embodiment, the frame size is adjustable by selecting the number of slots in each frame. The number of slots is set by an associated controller 107 and the frame is created by the mapper/framer device 106. The controller 107 is user provisionable to set the number of slots per frame anywhere between a minimum and a maximum value. The number of slots per frame has a direct correlation to the serial data rate of transmission over transmission medium 111. Notably, with a constant frame rate, a lower number of slots per frame results in less bandwidth that is transmitted, and therefore, a lower possible serial data rate. For example, in one embodiment, a serial data rate of 1.5 GHz contains enough bandwidth for 6 slots per frame, while a serial data rate of 3 GHz contains enough bandwidth for 12 slots per frame. For this example, controller 107 is a software algorithm. Controller 107, however, may be a hardware device, or any other mechanism capable of receiving an input from a user and controlling the creation of frames by the mapper/framer device 106.

The maximum number of slots per frame is limited by the maximum serial data rate of the transmission medium 111. For example, in one embodiment, the transmission medium 111 is a millimeter wave radio with a maximum serial data rate of 1.5 GHz. As previously mentioned, a 1.5 GHz transmission rate contains enough bandwidth for 6 slots per frame, therefore, in this embodiment, 6 slots is the maximum number of slots that can be placed in each frame without loss of data. At the users preference, however, the serial data rate can be set lower than the maximum, thereby placing a smaller number of slots in each frame. Some transmission mediums may not allow transmission at a lower serial data rate than the maximum, thus, in this situation, the serial data rate is set at the serial data rate of the transmission medium.

The minimum number of slots per frame is determined by the total amount of bandwidth to be sent over transmission medium 111. The total amount of bandwidth is equal to the sum of the bandwidth from each of A/D DDC devices 102a-102c (n=3 in this instance). For example, if A/D DDC 102a has 5 MHz of input bandwidth, A/D DDC 102b has 15 MHz of input bandwidth and A/D DDC 102c has 5 MHz of input bandwidth, the total bandwidth is 25 MHz. 25 MHz of input bandwidth fills four slots within a frame, thus the minimum number of slots per frame is four. Therefore, in this example embodiment, with a transmission medium having a 1.5 GHz serial data rate and 25 Mhz of total input bandwidth, the number of slots per frame can be set at 4, 5, or 6.

By selecting a suitable number of slots per frame, the present invention provides the ability to custom tailor the serial data rate over the transmission medium 111. For example, first communications unit 101, and second communications unit 103 may be initially installed to communicate over a 1.5 GHz millimeter wave transmission medium 111. Thus, the serial data rate is provisioned to 1.5 GHz and the number of slots per frame is set at 6 slots to match the 1.5 GHz serial data rate. Later on, if millimeter wave technology is updated to support a 3.0 GHz serial data rate, first communications unit 101 and second communications unit 103 are re-provisioned to a 3.0 GHz serial data rate and 12 slots per frame. Thus, first communications unit 101 and second communications unit 103 are easily adaptable to different transmission mediums and different serial data rates. Although for this illustrative embodiment, the frame size is adjusted to change the serial data rate, the present invention is not intended to be so limited and can include within its scope any means of adjusting the amount of data transmitted over transmission medium (e.g. adjusting the rate at which frames are sent, changing the size of the slot, etc.).

In another example, first communications unit 101 and second communications unit 103 transport data over a dark fiber optic cable (e.g. transmission medium 101). The dark fiber provider may charges a tariff based on the serial data rate being sent over the fiber up. In this example, first communications unit 101 takes in a total of 40 MHz of RF bandwidth, which requires 6 slots per frame. First communications unit 101 is, therefore, provisioned for 6 slots per frame and a 1.5 GHz serial data rate. Thus, rather than transmitting at higher data rate, e.g. 3.0 GHz, and filling the extra slots with empty data, a tariff is paid only on the actual serial data needed by system 100.

In any event, the frame(s) containing the multiplexed band segments are coupled from mapper/framer device 106 to a serializer device 108, which converts the parallel frame data from the mapper/framer device 106 to a serial bit stream. The serial data from serializer device 108 is coupled to an optical transmit device 110. The optical transmit device 110 processes and translates that data into coded light pulses that form a serial bit stream. An injection-laser diode or other suitable light source generates the light pulses, which are funneled with suitable optical lenses into the optical transmission medium (e.g., fiber optic cable) 111. For this example embodiment, mapper/frame device 106, serializer 108, and transmit device 110 are all implemented as part of a Serial Radio Frequency (SeRF) communicator 109. SeRF communicator 109 receives digital signals from each DART card 105a-105n and transmits a serial data stream over optical transmission medium 111 to another SeRF communicator 119 on second communications unit 103. In one embodiment, optical transmission medium 111 is a single mode optical fiber. In another embodiment, optical transmission medium 111 is a multi-mode optical fiber. Notably, an optical transport medium is used for this illustrative embodiment, but the present invention is not intended to be so limited and can include within its scope of coverage any suitable transport medium that can convey a serial bit stream.

For this example embodiment, second communications unit 103 includes a receive device 112, which includes a light sensitive device that detects the pulsed light signals (e.g., serial bit stream of frames) on transmission medium 111, converts the light signals to digital signals, and conveys them in serial form to a deserializer device 114. Again, it should be understood that although a light sensitive device is used for this illustrative embodiment, the present invention is not intended to be so limited and can include within its scope of coverage any suitable device that can receive and/or detect a serial bit stream from the particular transport medium being used.

Deserializer device 114 converts the serial frame data from receive device 112 to parallel frame data, which is coupled to a demapper/deframer device 116. Essentially, demapper/deframer device 116 demultiplexes the parallel frame data, and extracts the bandwidth segments from the demultiplexed frames. Demapper/deframer device 116 is capable of adjustable frame size selection that can be determined by user requirements similar to mapper/framer 106. The number of slots in each frame deconstructed by the demapper/deframer device 116 is set by an associated controller 117. The controller 117 is user provisionable to set the number of slots per frame anywhere between a minimum and a maximum value, similar to controller 107. For this example, controller 117 is a software algorithm. Controller 117, however, may be a hardware device, or any other mechanism capable of receiving an input from a user and controlling the deconstruction of frames by the demapper/deframer device 116.

The extracted bandwidth segments are coupled to the inputs of the appropriate output interfaces 118a-118n. For this illustrative embodiment, each output interface 118a-118n is implemented with a digital-to-analog (D/A) digital up-converter (D/A DUC) device which is implemented on a DART card 115a-115n. Each D/A DUC device 118a-118n converts the complex digital baseband signal to a real passband signal. For example, each digital baseband signal can be filtered, converted to the appropriate sampling rate by a respective sample clock 120a-120n, upconverted to an appropriate frequency, and modulated onto an analog signal. For this example embodiment, each sample clock 120a-120n is implemented on the respective DART card 115a-115n. For this example embodiment, the sample rate of each sample clock 120a-120n is selected to be the same as the sample rate of the corresponding sample clock 104a-104n in first communications unit 101. Thus, the analog bandwidth segments input to first communications unit 101 are transported via optical transmission medium 111 as a serial bit stream, and reconstructed at the corresponding output in second communications unit 103.

Notably, in the example embodiment depicted in FIG. 1, the output interfaces 102a-102n of communications unit 103 are implemented with a plurality of D/A DUC devices that can output a plurality of analog RF bandwidths, but the present invention is not intended to be so limited. In other embodiments, the output interfaces can be implemented with other types of output devices for other types of bandwidths. For example, in a second embodiment, in order to process a real digital signal at its input, each output interface 118a-118n can be implemented with a single D/A converter and analog up-conversion. In another embodiment, in order to process a complex digital signal at its input, each output interface 118a-118n can be implemented with dual D/A converters and analog up-conversion, or a DUC (e.g., digital up-conversion) and dual D/A converters. In sum, the plurality of output interfaces 118a-118n can be implemented with any suitable output interface device(s) capable of outputting analog or digital wideband segments.

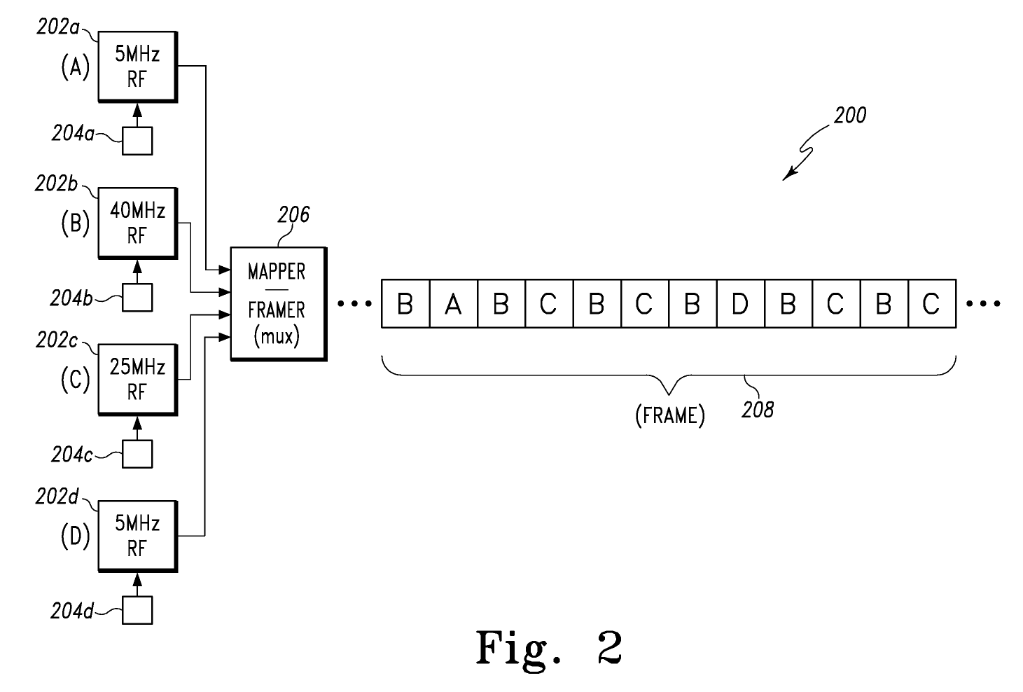

FIG. 2 depicts a pictorial representation of an example frame structure 200, which illustrates key principles of the present invention. Essentially, the frame structure 200 shown in FIG. 2 illustrates how the present invention allocates bandwidth proportionally, which allows a user to maximize the amount of bandwidth that can be transported on the serial bit stream. As such, the present invention enables users to transport different bandwidths efficiently on a plurality of wideband channels, instead of having to transport equal amounts of bandwidth inefficiently on those channels.

Specifically, referring to this illustrative example, it may be assumed that four different bandwidths are to be transported by system 100 depicted in FIG. 1. As such, for this example, bandwidth A (5 MHz RF) is input to A/D DDC device 202a, bandwidth B (40 MHz RF) is input to A/D DDC device 202b, bandwidth C (25 MHz RF) is input to A/D DDC device 202c, and bandwidth D (5 MHz RF) is input to A/D DDC device 202d. A respective sample clock 204a-204d inputs a unique sample rate to the associated A/D DDC device 202a-202d. The outputs from A/D devices 202a-202d are coupled to a mapper/framer device 206 and a serializer device (not shown), which multiplexes or combines the separate bandwidth segments (A, B, C, D) and constructs a suitable frame 208 including the bandwidth segments for transport. For this example frame structure, assume that the frame rate is approximately 15 MHz, and each of the frame's 12 slots includes 16 bits of digitized RF (with 14 bits of payload). The sample rate of sample clock 204a is selected to be approximately 15 Msps (for 5 MHz bandwidth segments), approximately 90 Msps for sample clock 204b (for 40 MHz bandwidth segments), approximately 60 Msps for sample clock 204c (for 25 MHz bandwidth segments), and approximately 15 Msps for sample clock 204d (for 5 MHz bandwidth segments). Thus, as illustrated by this example, the bandwidths in frame 208 are allocated proportionally, by transporting one slot for bandwidth A (5 MHz), six slots for bandwidth B (40 MHz), four slots for bandwidth C (25 MHz), and one slot for bandwidth D (5 MHz).

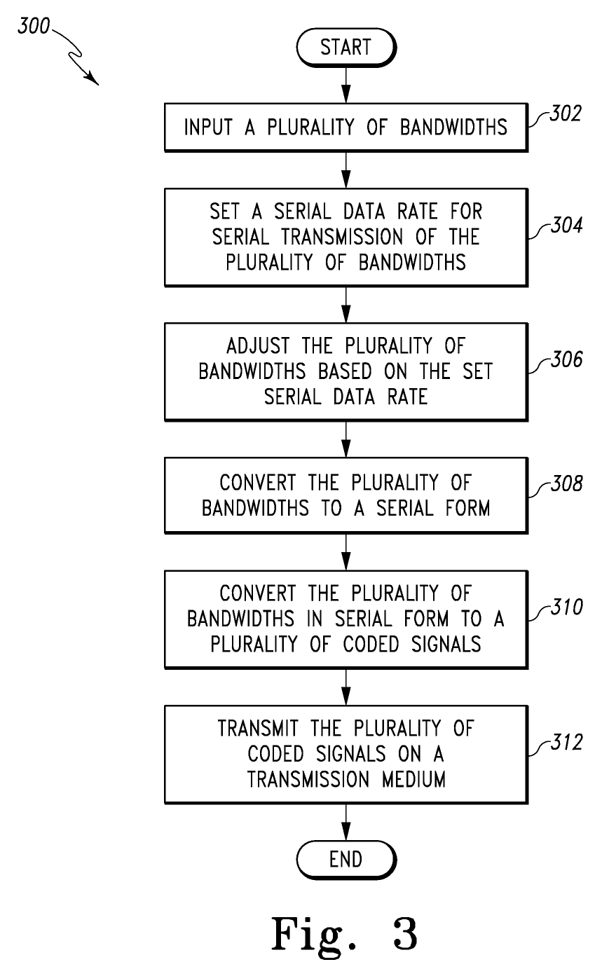

FIG. 3 depicts a flow chart of an example method 300 for enhancing the performance of a wideband digital RF transport system. In this example embodiment, method 300 is implemented on the example embodiment described with respect to FIGS. 1 and 2, however, the present invention is not intended to be so limited. For example, method 300 could be implemented on any wideband digital RF transport system having the ability to set the serial data rate for serial transmissions.

Method 300 starts by inputting a plurality of bandwidths (302) into an input interface 102a-102n. Input interfaces 102a-102n send the plurality of bandwidths to a mapper/framer 106. An associated controller 107 sets a serial data rate for serial transmission of the plurality of bandwidths (306). Using the set serial data rate, the associated controller 107 controls mapper/framer 106 as mapper framer 106 adjusts the plurality of bandwidths based on the set serial data rate (308). In this embodiment, a user provisions controller 107 to set a serial data rate and mapper/framer 106 adjusts the plurality of bandwidths by placing the desired amount of slots from the plurality of bandwidths into each frame created by mapper/framer 106. Although for this illustrative embodiment, the frame size is adjusted to match the plurality of bandwidths to the serial data rate, the present invention is not intended to be so limited and can include within its scope any means of adjusting the plurality of bandwidths including, for example, adjusting the rate at which frames are sent, or changing the size of the slots.

The plurality of bandwidths is converted to serial form (310) by serializer 108. Once the plurality of bandwidths are in serial form, they are converted into a plurality of coded signals (312) by transmit device 110. Transmit device 110 then transmits the plurality of coded signals over transmission medium 111 to second communications device 103. Although for this illustrative embodiment the steps of method 300 have been described in a certain order, the present invention is not intended to be so limited and can include variations in the order of the steps, except where explicitly limited in the method.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A method for enhancing the performance of a wideband digital RF transport system, the method comprising the steps of:
inputting a plurality of bandwidths;
setting a serial data rate for serial transmission of said plurality of bandwidths;
adjusting said plurality of bandwidths based on said set serial data rate;
converting said plurality of bandwidths to a serial form;
converting said plurality of bandwidths in serial form to a plurality of coded signals; and
transmitting said plurality of coded signals on a transmission medium.

2. The method of claim 1, further comprising the steps of:
setting an individual input sample rate for each bandwidth of said plurality of input bandwidths.

3. The method of claim 1, further comprising the steps of:
setting a serial data rate for serial reception of said plurality of bandwidths in serial form;
detecting said plurality of bandwidths in serial form from said plurality of coded signals;
converting said plurality of bandwidths in serial form to a parallel form; and
converting said plurality of bandwidths to a second plurality of bandwidths.

4. The method of claim 3, further comprising the step of:
setting an output sample rate for each bandwidth of said plurality of bandwidths.

5. The method of claim 1, wherein adjusting said plurality of bandwidths further comprises the step of:
converting said plurality of bandwidths to at least one frame structure, wherein said frame structure is configured to be transmitted at said serial data rate.

6. The method of claim 5, further comprising the step of:
controlling the conversion of said plurality of bandwidths to at least one frame structure by a controller.

7. A method for enhancing the performance of a wideband digital RF transport system, the method comprising the steps of:
inputting a plurality of bandwidths;
converting each of said plurality of bandwidths into a plurality of slots;
combining said plurality of slots from each bandwidth;
setting a number of slots per frame based on a serial data rate;
forming a plurality of frames from at least a portion of said combined plurality of slots, each frame having said set number of slots;
converting said plurality of frames to a serial form;
converting said plurality of frames in serial form to a plurality of coded signals; and
transmitting said plurality of coded signals on a transmission medium at said serial data rate.

8. The method of claim 7, further comprising the steps of:
setting an individual input sample rate for each bandwidth of said plurality of input bandwidths;
sampling each bandwidth of said plurality of bandwidths at its individual sample rate to form digital sampled data for each bandwidth; and
wherein the step of converting each of said plurality of bandwidths converts said digital sampled data for each bandwidth into a plurality of slots.

9. The method of claim 7, further comprising the steps of:
setting a serial data rate for serial reception of said plurality of bandwidths;
detecting said at least one frame structure from said plurality of coded signals;
converting said detected at least one frame to a parallel form;
deconstructing said at least one frame based on the set serial data rate to produce said combined plurality of slots;
separating said combined plurality of slots; and
converting said plurality of slots to a second plurality of bandwidths.

10. The method of claim 9, further comprising the step of:
setting an output sample rate for each bandwidth of said plurality of bandwidths.

11. The method of claim 7, wherein the step of converting said combined plurality of bandwidths is performed by a framer device.

12. The method of claim 7, wherein the step of setting a number of slots per frame is performed by a controller device.

13. A system for enhancing the performance of a wideband digital RF transport system, the system comprising:
a plurality of bandwidth input interface devices;
a plurality of sample rate devices coupled to said plurality of bandwidth input interface devices, each sample rate device of said plurality of sample rate devices configured to set an input sample rate of an associated bandwidth input interface device; and
a framer device coupled to an output of each bandwidth input interface device, and configured to create a first frame structure from said outputs of said bandwidth input interface devices when a serial data rate is set at a first rate, and configured to create a second frame structure from said outputs of said bandwidth input interface devices when said serial data rate is set at a second rate.

14. The system of claim 13, further comprising:
a control unit coupled to said framer device and configured to control said frame creation of said framer device.

15. The system of claim 14, wherein said controller controls the number of slots per frame.

16. The system of claim 13, wherein said plurality of bandwidth interface devices comprises a plurality of analog-to-digital digital down-converters.

17. The system of claim 13, wherein said plurality of sample rate device comprises a plurality of sample clocks.

18. The system of claim 13, wherein said transmit device comprises a laser transmitter device, and said transmission medium comprises an optical fiber.

19. The system of claim 13, further comprising:
a mapper combined with said framer device;
a serializer device coupled to an output of said framer device;
a transmit device coupled to an output of said serializer device; and
a transmission medium coupled to an output of said transmit device.

20. The system of claim 19, further comprising:
a digital signal detection device coupled to said transmission medium;
a deserializer device coupled to an output of said digital signal detection device;
a deframer device coupled to an output of said deserializer device, and configured to deconstruct a first frame when said serial data rate is set at a first rate and configured to deconstruct a second frame structure when said serial data rate is set at a second rate;
a control unit coupled to the deframer device and configured to control the deconstruction of said deframer device; and
a plurality of output interface devices.

21. A system for enhancing the performance of a wideband digital RF transport system, comprising:
a plurality of bandwidth input interface devices;
a plurality of sample rate devices coupled to said plurality of bandwidth input interface devices, each sample rate device of said plurality of sample rate devices configured to set an input sample rate of an associated bandwidth input interface device;
a mapper/framer device coupled to an output of each bandwidth input interface device, and configured to create a frame structure from the outputs of the bandwidth input interface devices;
a control unit coupled to the mapper/framer and configured to set a first serial data rate and control said mapper/framer to create first frame structure based on said first serial data rate, and configured to set a second serial data rate and control said mapper/framer to create a second frame structure based on said second data rate;
a serializer device coupled to an output of said framer device; and
a transmit device coupled to an output of said serializer device and configured to transmit at a serial data rate set by the control unit.

22. The system of claim 21, wherein said controller controls the number of slots per frame.

23. The system of claim 21, wherein said transmit device comprises a laser transmitter device, and said transmission medium comprises an optical fiber.

24. The system of claim 21, further comprising:
a transmission medium coupled to an output of said transmit device.

25. The system of claim 24, further comprising:
a digital signal detection device coupled to said transmission medium;
a deserializer device coupled to an output of said digital signal detection device;
a demapper/deframer device coupled to an output of said deserializer device, and configured to deconstruct a frame; and
a control unit coupled to the demapper/deframer device and configured to set a first serial data rate and control the demapper/deframer to deconstruct first frame structure based on said first serial data rate, and configured to set a second serial data rate and control the demapper/deframer to deconstruct a second frame structure based on said second data rate; and
a plurality of output interface devices.
